(19) United States
(12) Patent Application Publication
(10) Pub. No.: US 2026/0309283 A1
(43) Pub. Date: Oct. 8, 2026

(54) Securing Element, Pressure Vessel System and Motor Vehicle

(71) Applicant: Bayerische Motoren Werke Aktiengesellschaft, Muenchen (DE)

(72) Inventors: Jan GUNDLACH, Muenchen (DE); Timo GUTMANN, Bad Kohlgrub (DE)

(21) Appl. No.: 19/482,823

(22) PCT Filed: May 10, 2024
(86) PCT No.: PCT/DE2024/100421

§ 371 Date: Nov. 10, 2025

(30) Foreign Application Priority Data
May 11, 2023 (DE) 10 2023 112 421.8

(51) Int. Cl. F17C 13/08; B60K 15/03

(52) U.S. Cl. CPC F17C 13/084; B60K 15/03006; B60K 2015/03309; F17C 2201/0109; F17C 2205/0134; F17C 2205/0192; F17C 2221/012; F17C 2221/033; F17C 2270/0168

(57) ABSTRACT

A securing element for securing one or more pressure vessels, wherein the securing element is elongated and includes a channel for gaseous fuel. A pressure vessel system with a securing element of this type, and a motor vehicle with a pressure vessel system of this type are also disclosed.

### BACKGROUND AND SUMMARY

The technology disclosed herein relates to a securing element for securing one or more pressure vessels, to a pressure vessel system and to a motor vehicle.

Pressure vessels are used, by way of example, to store gaseous fuel in a motor vehicle or in another mobile or stationary arrangement. The use of pressure vessels of this kind is intended to extend in the future to an ever-increasing number of different applications, such as different types of motor vehicles, for example. Depending on the application, criteria such as space saving and simple construction play an ever-greater role.

A preferred object of the technology disclosed herein is to mitigate or remedy at least one disadvantage of a solution known in the prior art or to propose an alternative solution. In particular, a preferred object of the technology disclosed herein is to provide simplified mounting of pressure vessels. Further preferred objects may result from the advantageous effects of the technology disclosed herein.

The technology disclosed herein relates to a securing element for securing one or more pressure vessels, (i) wherein the securing element is of elongated design, (ii) wherein the securing element is designed such that one or more pressure vessels can be secured thereto, (iii) wherein a continuous channel for gaseous fuel is formed in the securing element, and (iv) wherein one or more connections are formed in the securing element to connect at least one pressure vessel in each case to the channel. By way of a securing element of this kind, it is possible to combine the functionalities of securing a pressure vessel and of supplying and/or discharging gaseous fuel in a single element. This saves on additional lines and ensures a compact and weight-saving configuration. In particular, the functionalities of securing a pressure vessel and of supplying and/or discharging gaseous fuel can be combined in only one profile or in only one elongated element.

A securing element may, in particular, be understood to mean an element to which one or more pressure vessels can be secured. Typically, several pressure vessels are secured thereto. In particular, the securing element can be designed in such a manner that in a given installation situation it can hold and support pressure vessels. An elongated design may, in particular, be understood to mean that the securing element is several times longer than its dimensions, in particular width and/or height, which are to be found in cross section. In particular, provision may be made along a longitudinal extent for multiple pressure vessels to be arranged next to one another. Different embodiments are possible for securing pressure vessels. For example, a pressure vessel can be placed with a connecting piece thereon.

Possible embodiments will be described in greater detail below. The continuous channel may, in particular, constitute a line for the gaseous fuel. It can be used to fill the pressure vessels with gaseous fuel. Alternatively or additionally, it can be used to discharge gaseous fuel from the pressure vessels. A discharge of this kind may be used, for example, to supply a consumer such as a fuel cell, for example. The connections are used, in particular, to establish a connection between the channel and a pressure vessel. In particular, this is a fluid connection. This allows a flow of fluid from the channel to the pressure vessel and/or in the reverse direction. The channel may, in particular, remain permanently in the securing element. If, for example, a pressure vessel is replaced, it can be easily connected to the connection and is thereby connected to the channel.

In particular, the channel can be used both for filling and for discharging. Otherwise, an additional line is typically present, which performs the other functionality in each case.

In particular, the securing element may be designed as an extrusion profile. This allows simple manufacture and a stable configuration.

In particular, the securing element can be designed so that one or more pressure vessels rest thereon. This may, in particular, be provided in such a manner that the securing element is sufficiently rigid to support the weight of multiple pressure vessels resting thereon. This can be ensured, for example, by a suitable choice of material, suitable material thicknesses and/or a particular configuration of the profile.

The pressure vessels may, in particular, rest on the securing element with a connecting piece of the pressure vessel in each case. In particular, provision may be made that the securing element is designed such that one or more pressure vessels rest thereon, so that the channel is located beneath the pressure vessel or the pressure vessels. This enables the functionality of supporting pressure vessels above the securing element to be integrated with the functionality of a channel.

In particular, the securing element may be formed as a single profile or a single, in particular continuous, element in which the channel is formed and which is designed to support one or more pressure vessels. This allows particularly high integration.

In particular, additional lines which, in the case of embodiments known from the prior art, are typically arranged over connecting pieces of pressure vessels, can be dispensed with.

The securing element may, in particular, have mechanical stability, so that the pressure vessels can rest on it on at least one of their sides, in particular without requiring further support of the pressure vessels. The channel may, in particular, also be arranged in an element that has this kind of mechanical stability. In particular, a wall of the channel may have the mechanical stability.

In particular, the channel may extend parallel to a longitudinal extent of the securing element. This makes it possible for the gaseous fuel to be distributed over the longitudinal extent and/or delivered from pressure vessels along the longitudinal extent.

In particular, the channel may have a circular, polygonal, rectangular or square cross section. With a circular cross section, a particularly advantageous distribution of pressure in all directions typically occurs. Other types of cross sections may, for example, be adapted to the conditions of a profile design.

The channel may, in particular, be configured to be open at a longitudinal end of the securing element. At this longitudinal end, a connection of the channel may, in particular, be provided. This makes it possible for gaseous fuel to be introduced into the channel, which is then to be delivered into the pressure vessels, and/or gaseous fuel can be withdrawn from the pressure vessels for use in a consumer. Both functionalities are also possible.

According to one embodiment, the channel is closed at both longitudinal ends of the securing element. In this case, a connection may in particular be provided, in order to allow a supply or discharge of gaseous fuel. In this case, the functionality is the same as just described with reference to an open longitudinal end. However, no open longitudinal end is required for this purpose; rather, a separate connection is used. This may, in particular, be arranged transversely to a longitudinal extent of the channel and/or the securing element.

According to an advantageous embodiment, the channel is lined with a permeation barrier to prevent an escape of gaseous fuel. A permeation barrier of this kind may, in particular, be formed as a barrier layer. This may, in particular, act in a permeation-inhibiting manner in respect of an escape of the gaseous fuel, so that an escape of gaseous fuel is avoided.

In particular, a longitudinal groove may be formed in the securing element on the upper side. The connections may, in particular, be arranged next to this groove. This longitudinal groove is, in particular, formed in such an upper-side position as is defined by reference to a typical usage situation of the securing element. The securing element therefore typically has a preferred orientation, wherein an upper side is clearly identifiable. Pressure vessels, for example, can rest on this side. A longitudinal groove may, in particular, be designed as an elongate indentation. This can increase stability. In addition, a projection of a connecting piece of a pressure vessel can engage in the longitudinal groove, in order to stabilize the pressure vessel. In the longitudinal groove, the pressure vessel can be displaceable along an extent of the longitudinal groove or along a longitudinal extent of the securing element.

The securing element may, for example, be made of aluminum. Other materials, such as steel, are also possible, however. Manufacture by a casting process is possible, for example.

In particular, the securing element may have one or more connecting means for connection to a vehicle body. The securing element can thereby be secured to the vehicle body. This allows a firm and permanent connection between the securing element and the vehicle body.

The technology disclosed herein further relates to a pressure vessel system comprising (i) at least one securing element as described herein, (ii) one or more pressure vessels for storing gaseous fuel with a connecting piece, and (iii) one or more connecting elements, wherein each pressure vessel is secured to the securing element by the connecting piece, and wherein each pressure vessel is connected by way of a connecting element to a connection of the securing element. By way of a pressure vessel system of this kind, the advantages mentioned at the outset can be achieved. With regard to the securing element, all embodiments and variants described herein can be applied. In particular, it is possible to secure the pressure vessels in a simple manner, in particular by having them rest thereon. In addition, a particularly simple connection of the pressure vessels for supplying and/or discharging gaseous fuel is possible.

The connecting pieces of the pressure vessels can, in particular, rest on the securing element. This allows particularly simple securing and also simple replacement or other removal of pressure vessels.

The pressure vessels can, in particular, be secured to the securing element in such a manner that they are movable in the longitudinal direction of the securing element. This can provide additional safety against impact events. If, for example, the securing element is installed transversely to the direction of travel of a motor vehicle, a lateral impact event can easily permit displacement of the pressure vessels transversely to the direction of travel, thereby attenuating the effect of the lateral impact event.

The pressure vessels can, in particular, be secured to the securing element in such a manner that they are immovable transversely to the longitudinal extent of the securing element. This can, in particular, be achieved in that the respective connecting piece encloses the securing element on two sides. This can be achieved, for example, by way of projections which extend along the longitudinal extent of the securing element. For example, a recess may be formed in the connecting piece, into which the securing element engages in the assembled state.

It may therefore be provided, in particular, that the pressure vessels are immovably secured transversely to the longitudinal extent of the securing element and/or that the pressure vessels are mounted movably along the longitudinal extent of the securing element. Further securing functions can be implemented by separate fixed or floating bearings, in particular at the opposite end of the pressure vessels, and/or by tensioning straps.

According to one embodiment, the connecting elements are of flexible design. They may be formed, for example, as flexible hoses. This permits a certain displacement of the pressure vessels relative to the securing element, without the connection between the channel and the pressure vessel being broken. In particular, in the event of an impact event, this can also prevent unintentional escape of gaseous fuel.

The connecting pieces may, in particular, have a recess between a first projection and a second projection. The pressure vessel can rest on the securing element with the recess, so that the first projection and the second projection bear laterally against the securing element. This recess therefore receives the securing element, in particular, and the projections can, in particular, ensure that the pressure vessel is not movable in a direction transverse to the longitudinal extent of the securing element, but is still movable parallel to the longitudinal extent of the securing element. In particular, a projection can engage in a longitudinal groove of the securing element. This is likewise regarded as lateral bearing. It is therefore sufficient if only part of the securing element is enclosed, in particular in cross-sectional view.

The pressure vessel system may, in particular, comprise one or more tensioning straps, wherein each tensioning strap encloses at least one pressure vessel or at least one connecting piece from above and is secured to the securing element. This allows simple securing of the pressure vessels to prevent them from being lifted upwards. This can increase resilience when driving on particularly uneven ground, for example.

The connecting elements can, in particular, be connected on the top side to a respective connecting piece of a pressure vessel and/or connected on the top side to the securing element. This allows simple assembly, since gripping from above is easily possible. A top-side connection of the connecting element can also be made indirectly, for example by way of a pressure connection which may, in particular, be curved. The connecting elements may, in particular, be designed as flexible or rigid lines.

The pressure vessel system may, in particular, comprise at least one floating bearing, in which the pressure vessels are mounted at a longitudinal end opposite the securing element. For example, a separate floating bearing may be provided for each pressure vessel.

A common floating bearing may also be provided for multiple or all pressure vessels. A floating bearing of this kind allows mounting or securing of the pressure vessels on one side opposite the securing element. By virtue of the design as a floating bearing, thermal expansions can be easily compensated, for example.

The technology disclosed herein further relates to a motor vehicle having a pressure vessel system as described herein. All embodiments and variants described herein can be applied with regard to the pressure vessel system. The pressure vessel system may, in particular, be installed in such a manner that the securing element extends transversely to the direction of travel. As already explained above, this permits simple design for increasing resilience to side-impact events.

In other words, it can be assumed in principle that combined hydrogen pressure tanks or other pressure vessels having a working pressure of, for example, 700 to 875 bar are used, and in known embodiments are connected via a rail for filling and withdrawal. Securing of the pressure vessel can be effected in a housing by so-called neck mounting on the boss or connecting piece of the respective pressure vessel, at one end of the pressure vessel by way of a fixed bearing, and at the other end by way of a floating bearing. This allows longitudinal expansions due to pressure and temperature change of a pressure vessel to be compensated. Described herein, in particular, is a securing concept with as few components as possible, in order to reduce weight and manufacturing effort and to reduce the accumulation of tolerances, while at the same time meeting the requirement of providing an impact-resistant solution, which means that no critical transverse forces are transmitted to a connecting piece that could result in a leak.

In composite tank systems of gas pressure tanks or pressure vessels, these are typically mounted individually or on a housing. This allows a corresponding number of identical components to be achieved. In addition, pressure vessels of this kind can be connected for filling and withdrawal. This typically takes place via a fixed rail and/or via individual line sections which connect the pressure vessels to one another in the supply path serially or in parallel, for example by way of T-pieces. The combination of the bearing function and the supply function in one component, as described herein, serves to reduce weight, components, manufacturing steps and tolerances.

Described herein is a supply rail of the individual pressure vessels which simultaneously serves as a fixed bearing. The pressure vessels can be placed on the web of the rail geometry with a connecting piece and a corresponding groove formed therein, the support in the longitudinal direction of the pressure vessels typically being provided in a form-fitting manner, while the lateral support and the upwards and/or downwards support can be provided by a tensioning strap, which can be screwed onto the rail. The securing element mentioned above can, in particular, be referred to as a rail. The supply of the pressure vessels can be provided via a bore extending along the rail, or as a continuous recess if the rail, as described herein, is formed as an extrusion profile. Small line branches, which are screwed into the rail and thereby connected to the hydrogen-conducting recess or bore in the rail, can lead to the connecting piece or boss of the tank. In the event of a lateral impulse, for example due to a crash impact, these are sufficiently flexible to prevent direct critical forces on the boss or the connecting piece. At the same time, the boss can be displaced in the transverse direction on the web of the rail, and by way of the elastic tensioning strap, critical loads on the boss can thereby also be prevented, and a leak thereby avoided.

In particular, a hydrogen flat storage system is described herein, which can preferably be used in an underfloor area of a passenger car, but also in other applications. For example, an installation situation in a motor vehicle in the underfloor space beneath the first and second seat rows may be considered. Multiple individual pressure vessels are typically accommodated there in a housing and are connected to one another in the supply and withdrawal path. The alignment of the pressure vessels in the housing may, in particular, correspond to the longitudinal axis of the vehicle within the left and right side sills.

A pressure vessel is used, in particular, for the storage of fuel in gaseous form under ambient conditions. The pressure vessel system described herein can, for example, be used in a motor vehicle operated using compressed natural gas (also referred to as CNG), liquified natural gas (also referred to as LNG) or hydrogen. The pressure vessels may, in particular, be fluidly connected to at least one energy converter that is configured to convert the chemical energy of the fuel into other forms of energy.

A pressure vessel system of this kind typically comprises at least one pressure vessel, in particular a composite overwrapped pressure vessel. The pressure vessel may, for example, be a cryogenic pressure vessel or a high-pressure gas vessel. High-pressure gas vessels are configured to permanently store fuel at ambient temperatures at a nominal working pressure (also referred to as NWP) of at least 350 bar(g) (i.e., gauge pressure relative to atmospheric pressure) or at least 700 bar(g). A cryogenic pressure vessel is configured to store the fuel at the aforementioned operating pressures, even at temperatures that are significantly (for example more than 50 K or more than 100 K) below the operating temperature of the motor vehicle.

The permeation barrier already mentioned further above may, for example, be formed as a liner. A liner may form a hollow body, in this case, for example, the channel. Likewise, a liner of this kind may be arranged in a pressure vessel. The liner may, for example, be made of aluminum or steel or alloys thereof. Furthermore, a liner can be made of a plastic. Depending on the materials used, however, a linerless embodiment is also possible.

### BRIEF DESCRIPTION OF THE DRAWINGS

FIG. 1 shows a pressure vessel system in an exploded view,

FIG. 2 shows a securing element,

FIG. 3 shows a sectional view of the securing element, and

FIG. 4 shows the pressure vessel system in an assembled state.

### DETAILED DESCRIPTION OF THE DRAWINGS

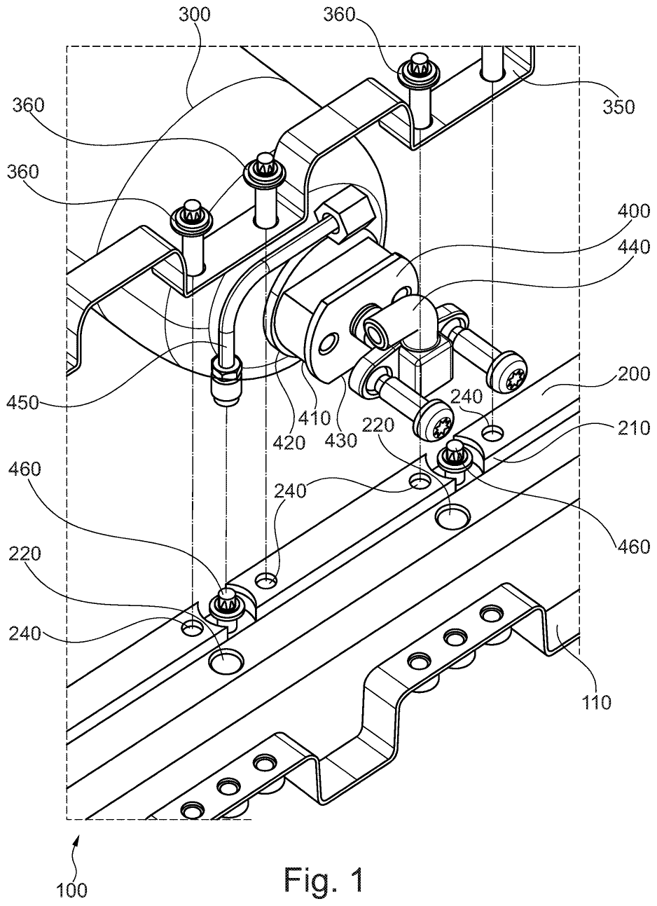

FIG. 1 shows purely schematically a pressure vessel system 100 according to an exemplary embodiment. The pressure vessel system 100 comprises a securing element 200. It further comprises a pressure vessel 300 with a connecting piece 400, as well as a tensioning strap 350. The pressure vessel 300 is representative of multiple pressure vessels arranged in parallel.

The securing element 200 is secured to a body element 110. This is used for securing and fixing the securing element 200. The pressure vessel 300 comprises the connecting piece 400 which has already been mentioned and which is used both for supporting the pressure vessel 300 and, on the other hand, for supplying and discharging gaseous fuel.

A recess 410 is formed in the connecting piece 400. For the lateral delimitation of the recess 410, a first projection 420 and a second projection 430 are used in this case. The recess 410 is located between these two projections 420, 430. The recess 410 is designed in such a manner that, in the assembled state, the securing element 200 engages in the recess 410. The securing element 200 is, as shown, of elongated design. In particular, it is designed as an elongate extrusion profile. This allows the pressure vessel 300 and also further pressure vessels (not shown) to be mounted in such a manner that the projections 420, 430 laterally enclose the securing element 200, or at least part of it, so that the connecting piece 400 rests on the securing element 200, namely in such a manner that no movement is possible transversely to the longitudinal extent of the securing element 200. In the embodiment shown, the second projection 430 engages in the longitudinal groove 210 for this purpose. Movement in the longitudinal direction of the securing element 200 is, however, still possible. This allows an advantageous reaction to side impact events when the securing element 200 is installed transversely in a vehicle, so that the pressure vessels 300 are installed longitudinally.

The connecting piece 400 further comprises a pressure connection 440. This extends from above into the rest of the connecting piece 400. In the assembled state, a connecting element 450, which is formed as an at least partially flexible hose, is connected thereto. Via the pressure connection 440 it is connected from above to the connecting piece 400. In the assembled state, it is connected to a connector 460, which is connected to a connection 220 of the securing element 200. The connection 220 is connected to a channel formed inside the securing element 200, not visible in FIG. 1, which will be described in greater detail below. The multiple connections 220 of the securing element 200 are arranged on one side of a longitudinal groove 210. On the other side of the longitudinal groove 210, screw holes 240 are provided for securing the tensioning strap 350 by way of screws 260.

The tensioning strap 350 encloses the connecting piece 400 from above in a manner similar to that in which, from below, the securing element 200 engages in the recess 410. In this way, a secure hold of the pressure vessel 300 is achieved. On an opposite side, which is not shown in FIG. 1, a floating bearing can in particular be provided, in order to permit thermal compensation. The tensioning strap 350 may, in particular, be sufficiently flexible to allow the longitudinal movement already described.

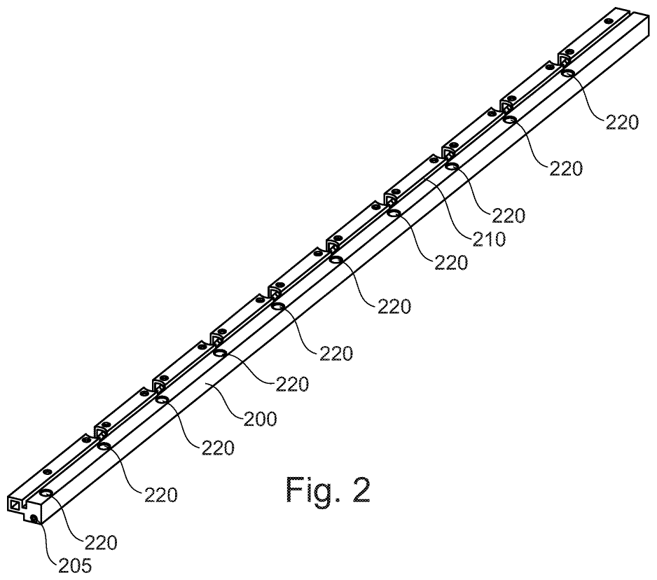

FIG. 2 shows the securing element 200 separately. In particular, the full length is shown in this case. As illustrated, it has a total of ten connections 220, so that a total of nine pressure vessels 300 can be secured thereto. The pressure vessels 300 are secured in a manner equivalent to the embodiment shown in FIG. 1. The connections are used to connect to a channel 205 which is formed in the securing element 200 and is open at the longitudinal end visible in FIG. 2. This is used, for example, for connection to a refueling device and/or a consumer.

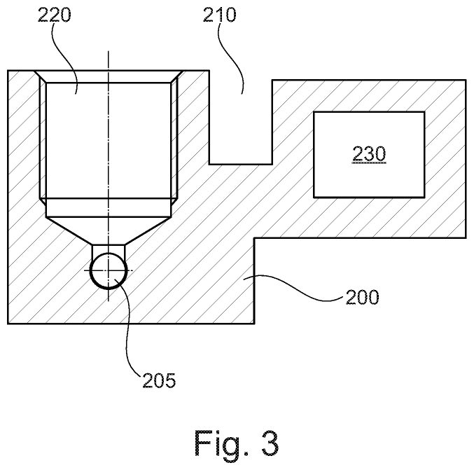

FIG. 3 shows the securing element 200 in a cross-sectional view. It can be seen that a channel 205 is located inside the securing element 200, which extends transverse to the plane of the drawing in FIG. 3 and thus in the longitudinal direction of the securing element 200. The connection 220 is connected to the channel 205 from above. This permits direct access to the channel 205. The channel 205 can thus serve to supply gaseous fuel to the pressure vessels 300 and/or to discharge gaseous fuel from the pressure vessels 300.

Parallel to the channel 205, a further cavity 230 is formed in the securing element 200. This cavity 230 does not serve to conduct gaseous fuel, but provides stability and weight reduction. Between the cavity 230 and the channel 205 is located the already mentioned longitudinal groove 210. The cross section shown overall serves to ensure stability with low weight.

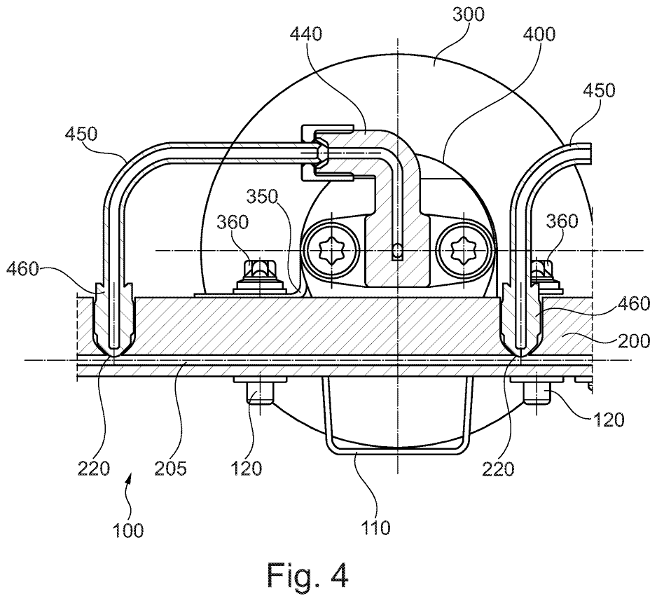

FIG. 4 shows the pressure vessel system 100 in an assembled state. Reference is made to the previous description of FIGS. 1 to 3 with regard to the individual elements. In particular, it can be seen that, in the connecting pieces 400, each connection is effected from above. Likewise, the connection to the channel 205 is effected from above in each case. This facilitates assembly and, if necessary, removal of the required components. Screws 120 can also be seen, with which the body element 110 is connected to the securing element 200. As shown, the tensioning strap 350 encloses the connecting piece 400 at the top side and thereby ensures that the connecting piece 400 would not be lifted even if a motor vehicle in which the pressure vessel system 100 was installed were to travel on a bumpy road, for example. However, there is also a certain degree of flexibility in the tensioning strap 350, so that displacement along the longitudinal extent of the securing element 200 is possible. This allows an advantageous reaction to a side impact event, in particular when the securing element 200 is installed transversely to the direction of travel of the vehicle and the pressure vessels 300 are therefore aligned in the longitudinal direction.

For reasons of readability, the expression “at least one” has in some cases been omitted for simplification. If a feature of the technology disclosed herein is described in the singular or in an indefinite form (e.g. the/a pressure vessel, the/a channel, etc.), the plural thereof (e.g. the at least one pressure vessel, the at least one channel, etc.) is likewise to be regarded as disclosed.

The foregoing description of the present disclosure is used merely for illustrative purposes and not for the purpose of limiting the disclosure. Within the scope of the disclosure, various changes and modifications are possible without departing from the scope of the disclosure and its equivalents.

### LIST OF REFERENCE SIGNS

100 Pressure vessel system
110 Body element
120 Screws
200 Fastening element
205 Channel
210 Longitudinal groove
220 Connection
230 Cavity
240 Screw holes
300 Pressure vessel
350 Tensioning strap
360 Screws
400 Connecting piece
410 Recess
420 First projection
430 Second projection
440 Pressure connection
450 Connecting element
460 Connector

1.-22. (canceled)

23. A securing element for securing one or more pressure vessels, wherein the securing element is of elongated design, wherein the securing element is designed such that one or more pressure vessels are secured thereto, wherein a continuous channel for gaseous fuel is formed in the securing element, wherein one or more connections are formed in the securing element to connect at least one pressure vessel in each case to the channel, and wherein the securing element is designed so that one or more pressure vessels rest thereon, so that the channel is located beneath the pressure vessel or the pressure vessels.

24. The securing element according to claim 23, wherein the securing element is designed as an extrusion profile.

25. The securing element according to claim 23, wherein the securing element is formed as a single profile in which the channel is formed and which is designed to support one or more pressure vessels.

26. The securing element according to claim 23, wherein the channel extends parallel to a longitudinal extent of the securing element.

27. The securing element according to claim 23, wherein the channel has a round, polygonal, rectangular or square cross section.

28. The securing element according to claim 23, wherein the channel is open at a longitudinal end of the securing element.

29. The securing element according to claim 23, wherein the channel is closed at both longitudinal ends of the securing element.

30. The securing element according to claim 23, wherein the channel is lined with a permeation barrier to prevent an escape of gaseous fuel.

31. The securing element according to claim 23, wherein a longitudinal groove is formed in the securing element on the upper side, wherein the connections are arranged next to the longitudinal groove.

32. The securing element according to claim 23, which is made of aluminum.

33. The securing element according to claim 23, which has one or more connecting means for connection to a vehicle body.

34. A pressure vessel system, comprising
at least one securing element according to claim 23,
one or more pressure vessels for storing gaseous fuel with a connecting piece, and
one or more connecting elements,
wherein each pressure vessel is secured with the connecting piece to the securing element, and
wherein each pressure vessel is connected by way of a connecting element to a connection of the securing element.

35. The pressure vessel system according to claim 34, wherein the connecting pieces of the pressure vessels rest on the securing element.

36. The pressure vessel system according to claim 34, wherein the pressure vessels are secured to the securing element in such a manner that they are movable in the longitudinal direction of the securing element.

37. The pressure vessel system according to claim 34, wherein the pressure vessels are secured to the securing element in such a manner that they are immovable transversely to the longitudinal extent of the securing element.

38. The pressure vessel system according to claim 34, wherein the connecting elements are of flexible design.

39. The pressure vessel system according to claim 34, wherein the connecting pieces have a recess between a first projection and a second projection, wherein the pressure vessel rests on the securing element with the recess, so that the first projection and/or the second projection bear laterally against the securing element and/or at least one projection engages in a longitudinal groove of the securing element.

40. The pressure vessel system according to claim 34, which comprises one or more tensioning straps, wherein each tensioning strap encloses at least one pressure vessel or at least one connecting piece from above and is secured to the securing element.

41. The pressure vessel system according to claim 34, wherein the connecting elements are connected on the top side to a respective connecting piece of a pressure vessel and/or connected on the top side to the securing element.

42. The pressure vessel system according to claim 34, comprising at least one floating bearing, in which the pressure vessels are mounted at a longitudinal end opposite the securing element.

43. A motor vehicle comprising a pressure vessel system according to claim 34.

44. The motor vehicle according to claim 43, wherein the pressure vessel system is installed in such a manner that the securing element extends transversely to a direction of travel.
